(19) United States
(12) Patent Application Publication
(10) Pub. No.: US 2005/0012323 A1
(43) Pub. Date: Jan. 20, 2005

(54) Stationery clip, mold assembly for making stationery clips and method of making stationery clips

(76) Inventor: Chih-Feng Lai, Taichung (TW)

Correspondence Address: Chih-Feng Lai, 58, MA YUAN WEST ST., TAICHUNG, TW

(21) Appl. No.: 10/623,315

(22) Filed: Jul. 17, 2003

(51) Int. Cl. B42D 7/00

(52) U.S. Cl. 281/45

(57) ABSTRACT

A mold assembly has an upper molding device and a lower molding device. The upper molding device has at least nine upper molds. The lower molding device has at least nine lower molds. A plurality of metal plates are electroplated in an electroplating device. Each of the metal plates has a colorful electroplated film. One of the metal plates is disposed between an upper molding device and a lower molding device to make a plurality of stationery clips.

### BACKGROUND OF THE INVENTION

The present invention relates to a stationery clip. More particularly, the present invention relates to a mold assembly having an upper molding device and a lower molding device for making stationery clips and a method of making stationery clips.

A conventional stationery clip which has a pin-shaped body or a peg-shaped body is made of a metal. The pin-shaped body has a round head and two parallel legs. The conventional stationery clip has a round cap engaging with the round head of the pin-shaped body. It is necessary to provide a first molding device to make the round cap and a second molding device to make the pin-shaped body. Furthermore, the round cap should be engaged with the round head of the pin-shaped body manually. Thus many conventional stationery clips should be assembled by many manual labors. The conventional stationery clip is not electroplated, so the conventional stationery clip will be rusted after a long period of usage.

### SUMMARY OF THE INVENTION

An object of the present invention is to provide a mold assembly having an upper molding device having nine upper molds in series and a lower molding device having nine lower molds in series for making stationery clips consecutively.

Another object of the present invention is to provide a method of making stationery clips consecutively in order to make each stationery clip in one piece.

Another object of the present invention is to provide a stationery clip which is electroplated to form a colorful electroplated film so that the stationery clip will not be rusted.

Accordingly, a mold assembly comprises an upper molding device and a lower molding device engaging with the upper molding device. The upper molding device has at least two first upper molds each having an oblong shape, at least a second upper mold having a tree shape, at least a third upper mold having a tree shape, at least a fourth upper mold having a tree shape, at least a fifth upper mold having a tree shape, at least a sixth upper mold having a taper interior, at least a seventh upper mold having a pair of inner bevels and a slit, at least an eighth upper mold having a slot, and at least a ninth upper mold in series. The ninth upper mold has a tree-shaped blade. A size of the third upper mold is larger than a size of the second upper mold. A size of the fourth upper mold is almost the same as the size of the second upper mold. A size of the fifth upper mold is slightly smaller than the size of the fourth upper mold. The lower molding device has at least two first lower molds each having an oblong recess, at least a second lower mold having a tree-shaped recess, at least a third lower mold having a tree-shaped recess, at least a fourth lower mold having a tree-shaped recess, at least a fifth lower mold having a tree-shaped recess, at least a sixth lower mold having a tree-shaped recess, at least a seventh lower mold having a tree-shaped recess, at least an eighth lower mold having a tree-shaped recess, and at least a ninth lower mold having a tree-shaped recess in series. The first lower molds match the first upper molds. The second lower mold matches the second upper mold. The third lower mold matches the third upper mold. The fourth lower mold matches the fourth upper mold. The fifth lower mold matches the fifth upper mold. The sixth lower mold matches the sixth upper mold. The seventh lower mold matches the seventh upper mold. The eighth lower mold matches the eighth upper mold. The ninth lower mold matches the ninth upper mold.

A method of making stationery clips comprises steps of:
a metal plate electroplated in an electroplating device to form a colorful electroplated film,
the metal plate disposed on the first lower mold and the first upper mold engaging with the first lower mold to punch the metal plate to form two wing strips,
the metal plate disposed on the second lower mold and the second upper mold engaging with the second lower mold to punch the metal plate to form a basic main body having a pair of connection parts each connected to the corresponding wing strip,
the metal plate disposed on the third lower mold and the third upper mold engaging with the third lower mold to punch the metal plate to form an enlarged main body on the basic main body, and the enlarged main body having a pair of connection portions each connected to the corresponding wing strip,
the metal plate disposed on the fourth lower mold and the fourth upper mold engaging with the fourth lower mold to punch the metal plate and to fold the wing strips upward in parallel,
the metal plate disposed on the fifth lower mold and the fifth upper mold engaging with the fifth lower mold to punch the metal plate and to form a tree-shaped recess on the enlarged main body,
the metal plate disposed on the sixth lower mold and the sixth upper mold engaging with the sixth lower mold to punch the metal plate and to fold the wing strips toward each other,
the metal plate disposed on the seventh lower mold and the seventh upper mold engaging with the seventh lower mold to punch the metal plate and to fold the wing strips close to each other,
the metal plate disposed on the eighth lower mold and the eighth upper mold engaging with the eighth lower mold to punch the metal plate and to form a dent on the enlarged main body, and
the metal plate disposed on the ninth lower mold and the ninth upper mold engaging with the ninth lower mold to cut an outer periphery of the enlarged main body to be disengaged from the metal plate to form a stationery clip.

### BRIEF DESCRIPTION OF THE DRAWINGS

FIG. 1 is a schematic view illustrating a plurality of metal plates of a preferred embodiment being electroplated in an electroplating device;

FIG. 2 is a perspective view of an upper molding device and a lower molding device of a preferred embodiment in accordance with the present invention;

FIG. 3 is a perspective view of a metal plate of a preferred embodiment having semi-finished stationery clips thereon;

FIG. 3A is a perspective view of a stationery clip of a preferred embodiment in accordance with th present invention;

FIG. 4 is a schematic view illustrating a metal plate disposed on a first lower mold, and a first upper mold disengaged from the first lower mold;

FIG. 4A is a schematic view illustrating a metal plate disposed on a first lower mold, and a first upper mold engaged with the first lower mold;

FIG. 5 is a schematic view illustrating a metal plate disposed on a second lower mold, and a second upper mold disengaged from the second lower mold;

FIG. 5A is a schematic view illustrating a metal plate disposed on a second lower mold, and a second upper mold engaged with the second lower mold;

FIG. 6 is a schematic view illustrating a metal plate disposed on a third lower mold, and a third upper mold disengaged from the third lower mold;

FIG. 6A is a schematic view illustrating a metal plate disposed on a third lower mold, and a third upper mold engaged with the third lower mold;

FIG. 7 is a schematic view illustrating a metal plate disposed on a fourth lower mold, and a fourth upper mold disengaged from the fourth lower mold;

FIG. 7A is a schematic view illustrating a metal plate disposed on a fourth lower mold, and a fourth upper mold engaged with the fourth lower mold;

FIG. 8 is a schematic view illustrating a metal plate disposed on a fifth lower mold, and a fifth upper mold disengaged from the fifth lower mold;

FIG. 8A is a schematic view illustrating a metal plate disposed on a fifth lower mold, and a fifth upper mold engaged with the fifth lower mold;

FIG. 9 is a schematic view illustrating a metal plate disposed on a sixth lower mold, and a sixth upper mold disengaged from the sixth lower mold;

FIG. 9A is a schematic view illustrating a metal plate disposed on a sixth lower mold, and a sixth upper mold engaged with the sixth lower mold;

FIG. 10 is a schematic view illustrating a metal plate disposed on a seventh lower mold, and a seventh upper mold disengaged from the seventh lower mold;

FIG. 10A is a schematic view illustrating a metal plate disposed on a seventh lower mold, and a seventh upper mold engaged with the seventh lower mold;

FIG. 11 is a schematic view illustrating a metal plate disposed on an eighth lower mold, and an eighth upper mold disengaged from the eighth lower mold;

FIG. 11A is a schematic view illustrating a metal plate disposed on an eighth lower mold, and an eighth upper mold engaged with the eighth lower mold;

FIG. 12 is a schematic view illustrating a metal plate disposed on a ninth lower mold, and a ninth upper mold disengaged from the ninth lower mold;

FIG. 12A is a schematic view illustrating a metal plate disposed on a ninth lower mold, and a ninth upper mold engaged with the ninth lower mold; and

FIG. 13 is a schematic view illustrating an application of a pair of stationery clips of a preferred embodiment in accordance with the present invention.

### DETAILED DESCRIPTION OF THE INVENTION

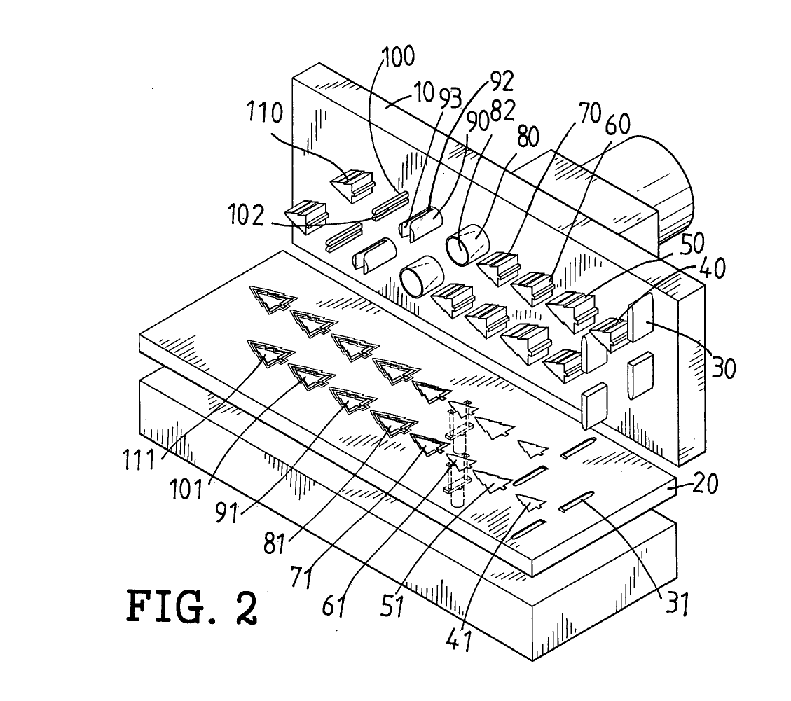

Referring to FIG. 2, a mold assembly comprises an upper molding device 10 and a lower molding device 20 engaging with the upper molding device 10.

The upper molding device 10 comprises at least two first upper molds 30 each having an oblong shape, at least a second upper mold 40 having a tree shape, at least a third upper mold 50 having a tree shape, at least a fourth upper mold 60 having a tree shape, at least a fifth upper mold 70 having a tree shape, at least a sixth upper mold 80 having a taper interior 82, at least a seventh upper mold 90 having a pair of inner bevels 93 and a slit 92, at least an eighth upper mold 100 having a slot 102, and at least a ninth upper mold 110 in series.

The ninth upper mold 110 has a tree-shaped blade.

A size of the third upper mold 50 is larger than a size of the second upper mold 40.

A size of the fourth upper mold 60 is almost the same as the size of the second upper mold 40.

A size of the fifth upper mold 70 is slightly smaller than the size of the fourth upper mold 60.

The lower molding device 20 comprises at least two first lower molds 31 each having an oblong recess, at least a second lower mold 41 having a tree-shaped recess, at least a third lower mold 51 having a tree-shaped recess, at least a fourth lower mold 61 having a tree-shaped recess, at least a fifth lower mold 71 having a tree-shaped recess, at least a sixth lower mold 81 having a tree-shaped recess, at least a seventh lower mold 91 having a tree-shaped recess, at least an eighth lower mold 101 having a tree-shaped recess, and at least a ninth lower mold 111 having a tree-shaped recess in series.

The first lower molds 31 match the first upper molds 30. The second lower mold 41 matches the second upper mold 40. The third lower mold 51 matches the third upper mold 50. The fourth lower mold 61 matches the fourth upper mold 60. The fifth lower mold 71 matches the fifth upper mold 70. The sixth lower mold 81 matches the sixth upper mold 80. The seventh lower mold 91 matches the seventh upper mold 90. The eighth lower mold 101 matches the eighth upper mold 100. The ninth lower mold 111 matches the ninth upper mold 110.

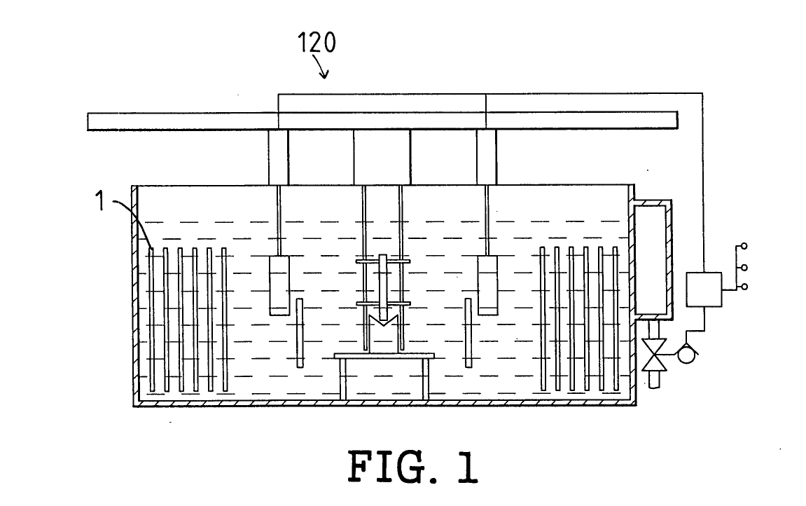

Referring to FIG. 1, a plurality of metal plates 1 are electroplated in an electroplating device 120.

Each of the metal plates 1 has a colorful electroplated film.

Referring to FIGS. 1 to 12A, one of the metal plates 1 is disposed between the upper molding device 10 and the lower molding device 20. A hauling device (not shown in the figures) draws the metal plate 1 to pass through the upper molding device 10 and the lower molding device 20.

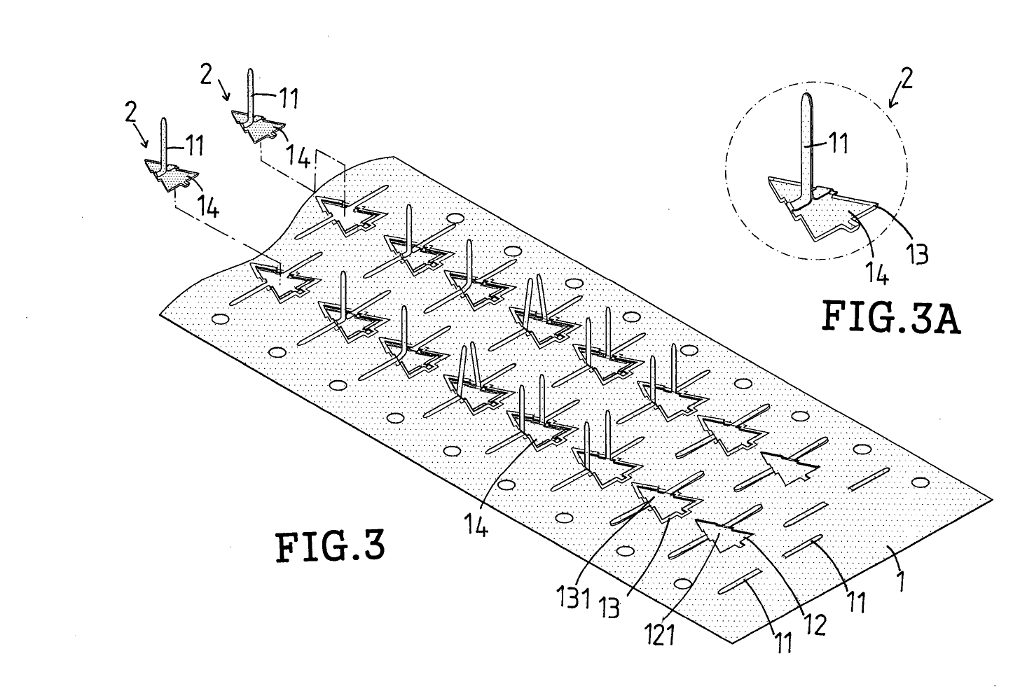

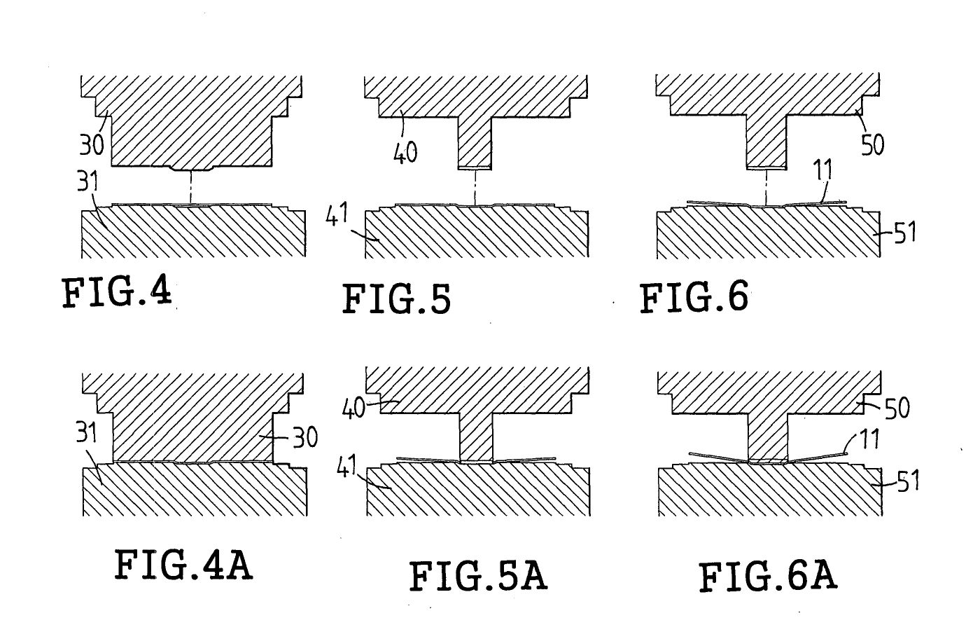

Referring to FIGS. 3, 4 and 4A, the metal plate 1 is disposed on the first lower mold 31, and the first upper mold 30 engages with the first lower mold 31 to punch the metal plate 1 to form two wing strips 11.

Referring to FIGS. 3, 5 and 5A, the metal plate 1 is disposed on the second lower mold 41, and the second upper mold 40 engages with the second lower mold 41 to punch the metal plate 1 to form a basic main body 12 having a pair of connection parts 121 each connected to the corresponding wing strip 11.

Referring to FIGS. 3, 6 and 6A, the metal plate 1 is disposed on the third lower mold 51, and the third upper mold 50 engages with the third lower mold 51 to punch th metal plate 1 to form an enlarged main body 13 on the basic main body 12.

The enlarged main body 13 has a pair of connection portions 131 each connected to the corresponding wing strip 11.

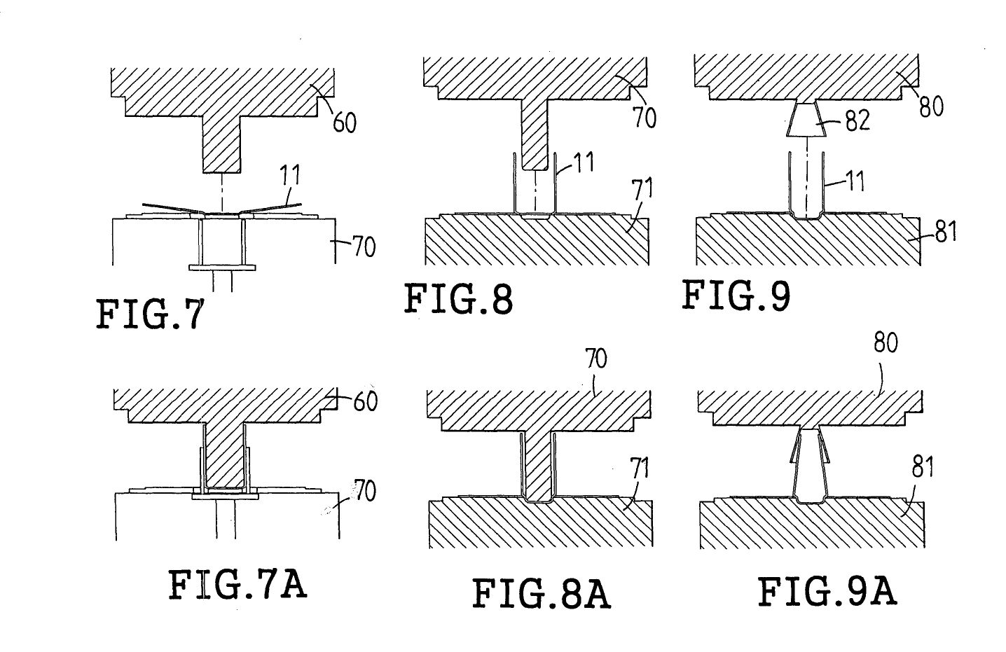

Referring to FIGS. 3, 7 and 7A, the metal plate 1 is disposed on the fourth lower mold 61, and the fourth upper mold 60 engages with the fourth lower mold 61 to punch the metal plate 1 so that the wing strips 11 will be folded upward in parallel.

Referring to FIGS. 3, 8 and 8A, the metal plate 1 is disposed on the fifth lower mold 71, and the fifth upper mold 70 engages with the fifth lower mold 71 to punch the metal plate 1 so that a tree-shaped recess 14 is formed on the enlarged main body 13.

Referring to FIGS. 3, 9 and 9A, the metal plate 1 is disposed on the sixth lower mold 81, and the sixth upper mold 80 engages with the sixth lower mold 81 to punch the metal plate 1 so that the wing strips 11 will be folded upward toward each other.

Referring to FIGS. 3, 10 and 10A, the metal plate 1 is disposed on the seventh lower mold 91, and the seventh upper mold 90 engages with the seventh lower mold 91 to punch the metal plate 1 so that the wing strips 11 will be folded close to each other.

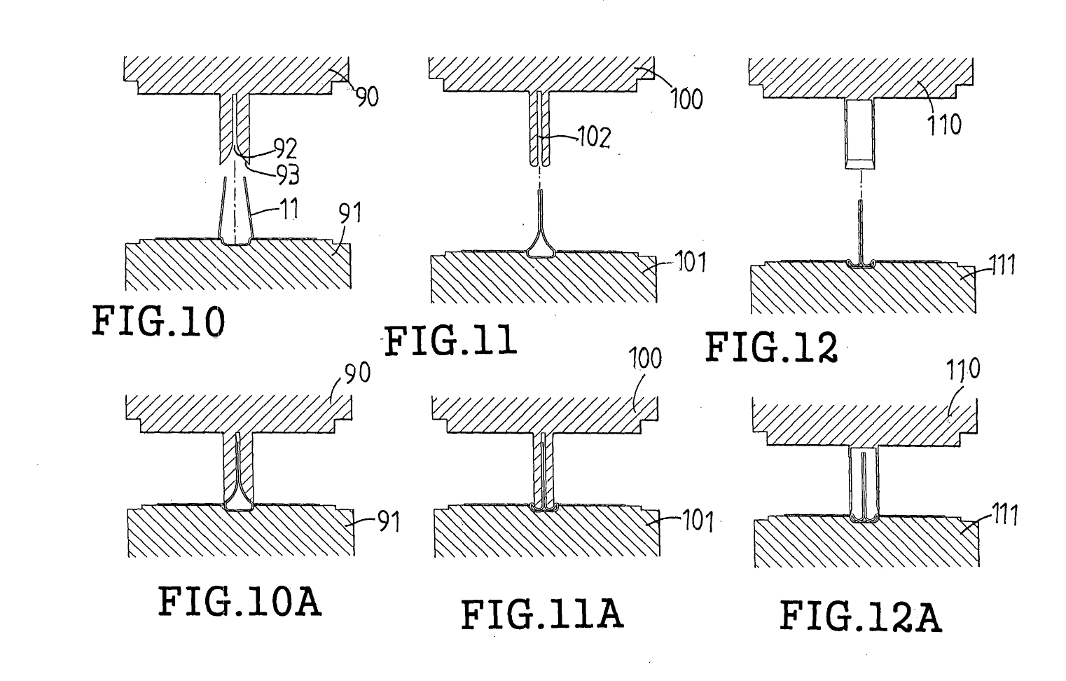

Referring to FIGS. 3, 11 and 11A, the metal plate 1 is disposed on the eighth lower mold 101, and the eighth upper mold 100 engages with the eighth lower mold 101 to punch the metal plate 1 so that a dent 15 is formed on the enlarged main body 13.

Referring to FIGS. 3, 12 and 12A, the metal plate 1 is disposed on the ninth lower mold 101, and the ninth upper mold 100 engages with the ninth lower mold 101 to cut an outer periphery of the enlarged main body 13 so that the enlarged main body 13 will be disengaged from the metal plate 1 to form a stationery clip 2.

Referring to FIG. 3A, the stationery clip 2 has the generally tree-shaped main body 13 and a pair of wing plates 11 connected to the generally tree-shaped main body 13. The tree-shaped recess 14 is formed on the tree-shaped main body 13.

The wing plates 11 and the generally tree-shaped main body 13 are made in one piece.

The wing plates 11 are folded upward to be combined together.

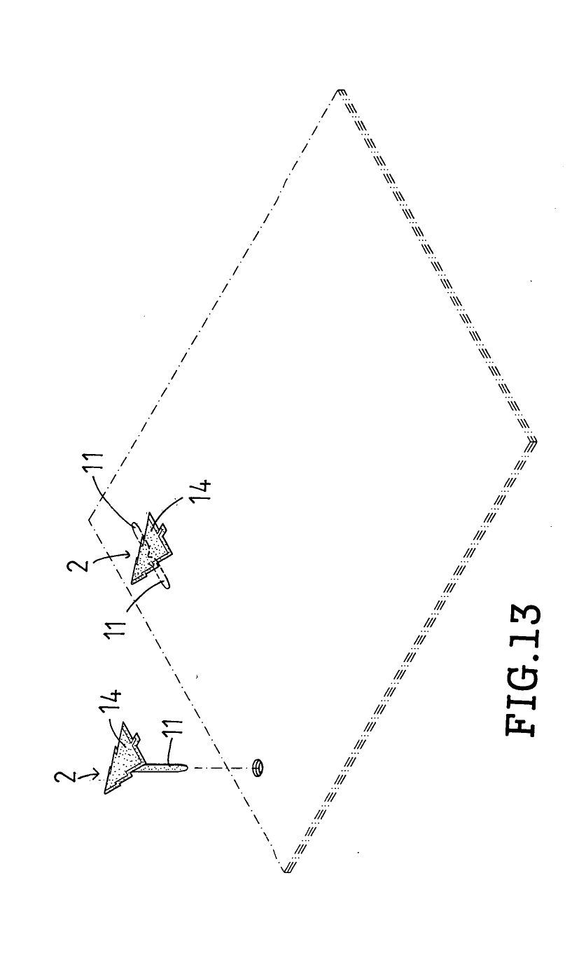

Referring to FIG. 13, two stationery clips 2 are disposed on a stationery article.

The present invention has the following advantages. The mold assembly has the upper molding device having nine upper molds in series and the lower molding device having nine lower molds in series in order to make stationery clips consecutively. The method of making stationery clips is processed consecutively in order to make each stationery clip in one piece. The stationery clip is electroplated to form a colorful electroplated film so that the stationery clip will not be rusted.

The invention is not limited to the above embodiment but various modification thereof may be made. Further, various changes in form and detail may be made without departing from the scope of the invention.

1. A mold assembly comprises:
an upper molding device and a lower molding device engaging with the upper molding device,
the upper molding device having at least two first upper molds each having an oblong shape, at least a second upper mold having a tree shape, at least a third upper mold having a tree shape, at least a fourth upper mold having a tree shape, at least a fifth upper mold having a tree shape, at least a sixth upper mold having a taper interior, at least a seventh upper mold having a pair of inner bevels and a slit, at least an eighth upper mold having a slot, and at least a ninth upper mold in series,
the ninth upper mold having a tree-shaped blade,
a size of the third upper mold larger than a size of the second upper mold,
a size of the fourth upper mold almost the same as the size of the second upper mold,
a size of the fifth upper mold slightly smaller than the size of the fourth upper mold,
the lower molding device having at least two first lower molds each having an oblong recess, at least a second lower mold having a tree-shaped recess, at least a third lower mold having a tree-shaped recess, at least a fourth lower mold having a tree-shaped recess, at least a fifth lower mold having a tree-shaped recess, at least a sixth lower mold having a tree-shaped recess, at least a seventh lower mold having a tree-shaped recess, at least an eighth lower mold having a tree-shaped recess, and at least a ninth lower mold having a tree-shaped recess in series,
the first lower molds matching the first upper molds,
the second lower mold matching the second upper mold,
the third lower mold matching the third upper mold,
the fourth lower mold matching the fourth upper mold,
the fifth lower mold matching the fifth upper mold,
the sixth lower mold matching the sixth upper mold,
the seventh lower mold matching the seventh upper mold,
the eighth lower mold matching the eighth upper mold, and
the ninth lower mold matching the ninth upper mold.

2. A method of making stationery clips comprises steps of:
a metal plate electroplated in an electroplating device to form a colorful electroplated film,
the metal plate disposed on the first lower mold and the first upper mold engaging with the first lower mold to punch the metal plate to form two wing strips,
the metal plate disposed on the second lower mold and the second upper mold engaging with the second lower mold to punch the metal plate to form a basic main body having a pair of connection parts each connected to the corresponding wing strip,
the metal plate disposed on the third lower mold and the third upper mold engaging with the third lower mold to punch the metal plate to form an enlarged main body on the basic main body, and the enlarged main body having a pair of connection portions each connected to the corresponding wing strip,
the metal plate disposed on the fourth lower mold and the fourth upper mold engaging with the fourth lower mold to punch the metal plate and to fold the wing strips upward in parallel,
the metal plate disposed on the fifth lower mold and the fifth upper mold engaging with the fifth lower mold to punch the metal plate and to form a tree-shaped recess on the enlarged main body,
the metal plate disposed on the sixth lower mold and the sixth upper mold engaging with the sixth lower mold to punch the metal plate and to fold the wing strips toward each other,
the metal plate disposed on the seventh lower mold and the seventh upper mold engaging with th s venth lower mold to punch the m tal plate and to fold the wing strips close to each other,
the metal plate disposed on the eighth lower mold and the eighth upper mold engaging with the eighth lower mold to punch the metal plate and to form a dent on the enlarged main body, and
the metal plate disposed on the ninth lower mold and the ninth upper mold engaging with the ninth lower mold to cut an outer periphery of the enlarged main body to be disengaged from the metal plate to form a stationery clip.

3. A stationery clip has:
a generally tree-shaped main body and a pair of wing plates connected to the generally tree-shaped main body,
a tree-shaped recess formed on the tree-shaped main body,
the wing plates and the generally tree-shaped main body made in one piece, and
the wing plates being folded upward to be combined together.

4. The stationery clip as claimed in claim 3, wherein the generally tree-shaped main body is electroplated to form a colorful electroplated film thereon.
